(19) United States
(12) Patent Application Publication
(10) Pub. No.: US 2018/0081342 A1
(43) Pub. Date: Mar. 22, 2018

(54) AUTOMATION TECHNOLOGY PROCESS CONTROL SYSTEM

(71) Applicant: Endress+Hauser Conducta GmbH+Co. KG, Gerlingen (DE)

(72) Inventors: Guido Mennicken, Leonberg (DE); Sebastian Schmidt, Stuttgart (DE); Maximiliane Bayo, Tubingen (DE)

(21) Appl. No.: 15/702,240

(22) Filed: Sep. 12, 2017

(30) Foreign Application Priority Data
Sep. 19, 2016 (DE) 10 2016 117 631.1

(51) Int. Cl. G05B 19/418

(52) U.S. Cl. CPC G05B 19/418; G05B 2219/31368; G05B 2219/32128; G05B 2219/32014; G05B 2219/40619

(57) ABSTRACT

The present disclosure relates to an automation technology process control system for controlling at least one field device having an electronic measurement and/or operation unit, including a user interface for operating the electronic measurement and/or operation unit of the at least one field device, characterized in that the at least one user interface is designed as a tangible user interface.

### CROSS-REFERENCE TO RELATED APPLICATION

The present application is related to and claims the priority benefit of German Patent Application No. 10 2016 117 631.1, filed Sep. 19, 2016, the entire contents of which are incorporated herein by reference.

### TECHNICAL FIELD

The present disclosure relates to an automation technology process control system having at least one field device.

### BACKGROUND

Field devices serving to capture and/or modify process variables are frequently used in process automation technology. Sensors, such as fill-level measuring devices, flow meters, pressure and temperature measuring devices, pH redox potential meters, conductivity meters, etc., which record the corresponding process variables, such as fill-level, flow rate, pressure, temperature, pH level or conductivity, are, in particular, used to capture process variables. Actuators, such as valves or pumps, for example, are used to influence process variables, via which actuators the flow rate of a fluid in a pipeline section or the fill-level in a container can be altered. Field devices, in general, refer to all devices which are process-oriented and which provide or edit process-relevant information. A variety of such field devices are manufactured and marketed by the Endress+Hauser company.

In process automation, the individual instruments must be configured using numerous parameters (for example, measurement interval, cleaning interval, calibration interval, etc.). For communication of the field devices amongst one another, the communication protocol, the communication channel, the association of individual relays, etc., must be established. The communication with the control system in turn requires the association of the individual devices with the individual measurement locations for example, by means of IP address. During start-up, various instruments, e.g., sensors and analyzers, must be adjusted, and corresponding calibration factors must be stored and associated. The various parameters and layers of the process control make it difficult for the user to oversee the configuration of the individual components and capture the state of individual devices, or of the entire system.

The association of individual sensors currently takes place via classical control menus, or via information stored in the sensor itself. The association of individual relays typically takes place via classical control menus. The current state of the configuration and communication is likewise indicated in a menu tree or with the aid of diagnosis messages.

### SUMMARY

The present disclosure is based upon the aim of providing an alternative automation technology user interface for controlling field devices.

The aim is achieved by the subject matter of the present disclosure. The subject matter of the present disclosure is an automation technology process control system for controlling at least one field device having an electronic measurement and/or operation unit, comprising a user interface for operating the electronic measurement and/or operation unit of the at least one field device, characterized in that the at least one user interface is designed as a tangible user interface (TUI).

In process automation, the use of a tangible user interface markedly simplifies the parameterization and start-up of individual measurement locations and entire process systems. For example, an integration of sensitive control interfaces is conceivable for online analyzers, transmitters, and process control systems.

According to an embodiment, the tangible user interface (TUI) comprises a sensitive control interface.

According to a variant, the process control system comprises a control element arranged so as to be movable on the user interface, which control element is associated with the at least one field device, wherein the at least one control element is a miniaturization of the at least one field device.

According to an embodiment, the user interface is designed so that the user interface can be varied with the characteristics and/or the configuration of the process control system and/or at least one field device. For example, a clockwise rotation of the control element might entail an increase in an offset value, and a counterclockwise rotation might produce a reduction in the offset value.

According to an embodiment, the characteristics and/or configurations of the process control system are encoded visually, magnetically, or in terms of the surface quality in the user interface, and can be detected automatically by the control interface.

According to an development, the at least one control element is an article separate from the control interface, wherein the control element can be arranged on the control interface.

According to a variant, the user interface has light sources to display a current status of the at least one field device.

The light source may have a defined color, e.g., red for errors, green for OK, or yellow for service required. In an embodiment, the user interface may be produced from a transparent material and may be indirectly illuminated (e.g., backlit). The display of the current status of the at least one field device may be encoded or unencoded. The light source may also indicate the current status in the form of graphics, text, or cockpit depictions of state parameters of the field device. The current status of a field device is indicated at a defined position on the user interface. However, the position may be varied according to the status. If the position of the user interface is modified, the position of the graphics on the display is simultaneously modified.

According to an embodiment, the process control system comprises at least two control elements having a respective monitoring unit which monitors an interaction of the two field devices associated therewith, wherein the monitoring unit is designed such that, in the event that the two field devices do not interact, the two field devices cannot be operated by the two control elements.

The function of the field devices is activated only if two or more control elements are joined correctly. Example: for safety reasons, a high-pressure device that is set under pressure by means of a compressor requires a functioning pressure sensor that interacts with the compressor. The monitoring unit can start the compressor only after the control element of the compressor and the control element of the pressure sensor serving for monitoring have been correctly joined and the communication with the pressure sensor and its problem-free function have been checked.

According to an embodiment, the process control system comprises at least two control elements having a respective monitoring unit which monitors an interaction of the two field devices associated therewith, wherein the monitoring unit is designed such that, in the event that the two field devices cannot be operated together, the two field devices cannot be operated simultaneously by the two control elements.

For example, pumps A and B may run individually, but never both simultaneously. Therefore, there is only one common control element that activates either pump A or pump B, depending upon location or position. In this way, an operating error is precluded.

According to an development, the process control system comprises at least one blocking element for blocking or barring a control element for a user, wherein the at least one blocking element can be imposed via the at least one control element, and the state of the field device can no longer be modified on this control element.

This special user interface stands for a specific state of the field device, for example, service mode, and possesses a higher functional priority than the user interfaces of the field devices.

Positions of the control element may thus be fixed by magnets, and a change in state for example, the rotation of the element may be precluded. The user receives a haptic feedback, for example, in the form of a magnetic resistance, that a change in state is not allowed.

According to a variant, the process control system comprises a distance measurement device for measuring the distance between the user interface and the at least one control element, and which determines and deactivates the associated field device and/or the control of the field device beyond a predetermined distance. The field device is then transitioned into a defined, safe state.

### BRIEF DESCRIPTION OF THE DRAWINGS

The present disclosure is explained in more detail based upon the following drawings. Illustrated are:

FIG. 1 shows a plan view of a user interface having one control element; and

FIG. 2 shows a plan view of a user interface having two control elements.

### DETAILED DESCRIPTION

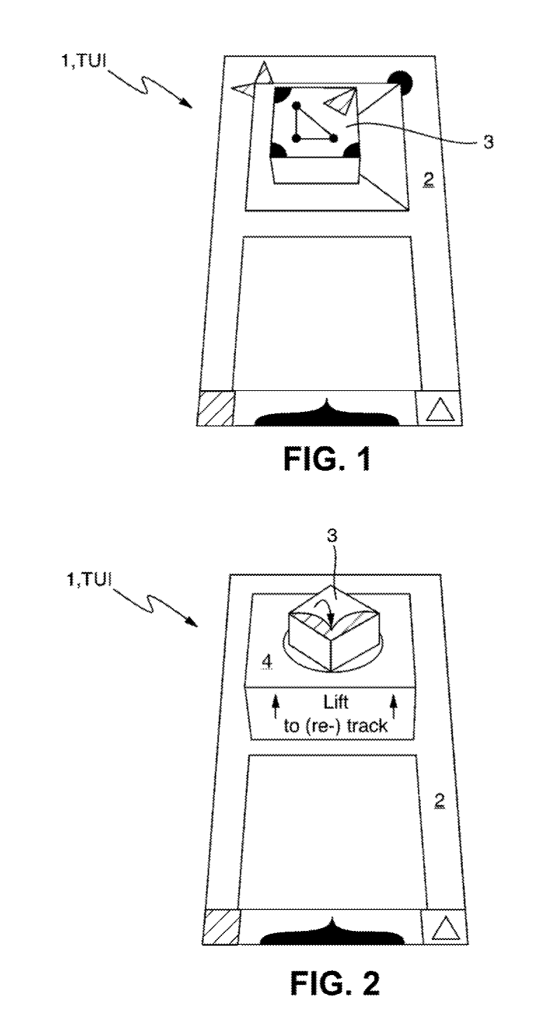

FIG. 1 shows a plan view of a user interface 1 of an automation technology process control system for controlling field devices having an electronic measurement and/or operation unit.

The user interface 1 serves for operation of the electronic measurement and/or operation unit of the field device, and is designed as a tangible user interface (TUI). The user interface also comprises a sensitive control interface 2 that has a two-dimensional pattern. An upper quadratic field is designated for a cuboid control element 3. A lower field on the control interface 3 serves as a graphical user interface (GUI) element of the observed augmented reality (AR).

The control element 3 may assume two possible positions in the upper field: arrow to the upper right or to the upper left. Both positions may be detected as a pattern by the AR software.

If a position of the control element 3 in the upper field is detected, the lower field and the upper surface of the buttons themselves become “tappable” surfaces with which various functions may be associated, depending upon the position of the control element 3. Both the control element 3 and the control interface 2 are folded together from paper.

The control element 3 is associated with a field device and designed as a miniaturization of the field device. There are colored markings on the user interface 1 and the control element 3, by means of which colored markings the position of the control element 3 relative to the control interface 2 is clarified.

The characteristics and the configuration of the process control system and of the field device are stored in the user interface 1 and are visually represented in encoded form on a control interface 2 of the user interface 1. The user interface 1 also has light sources to display a current status of the at least one field device. The current status is likewise presented on the control interface 2.

Each side of the cuboid control element 3 stands for a measurement area; alternatively, each side may symbolize a selectable measurement interval.

The selection of the measurement area or of the measurement interval would in this way be a great deal simpler, faster, and more intuitive than via conventional user interfaces.

In addition to the control elements mentioned, additional control elements may be inserted around the control element 3, for example, geometric shapes on a circle or a rectangle.

An illumination of the control element 3 in a specific color may encode additional information. In a particular embodiment, the control elements 3 are transparent or partially transparent and illuminated in the respective color.

The user interface 1 may be combined on the display with a graphical scheme of the process system. The graphical system scheme, with tanks, buildings, and tubes, may include provided positions for control elements 3 of individual measurement positions. This means that the tank is drawn as fixed. All process instruments, such as fill-level detectors, transmitters for pH and conductivity and online analyzers, are configured and visualized via control elements 3.

FIG. 2 shows a plan view of a user interface 1 having first and second control elements 3, 4. The first control element 3 is arranged over the second control element 4, wherein the second control element 4 is arranged on the upper field of the control interface 2. In this way, the first and second control elements 3, 4 may be operated independently of one another.

The first control element 3 has a mathematical form similar to that of the second control element 4. However, the second control element 4 is larger than the first control element 3. An area of the second control element 4 is quadratic and flush with the upper field of the control interface 2.

The second control element 4 may assume two positions, “left” and “right,” both of which are detected by AR software. In the second control element 4, a change in the switch position is also detected if the field provided with the triangle is also simultaneously covered, which is different than in the first control element 3.

A user interaction is therefore also possible by contacting the (physical) surface. A contact with a physical surface can be detected if a triggered pattern is thereby covered to the extent that the remaining characteristics are not sufficient for pattern recognition. The principle of this expansion-supported TUI lies in this concept. The large (middle) button thus also serves to cover a portion of the triggered pattern. However, the pattern is designed so that this alone is not sufficient; rather, the yellow area still needs to be covered. This design can be extended modularly, and “towers” with more complex behavior are also conceivable.

1. An automation technology process control system for controlling at least one field device having an electronic measurement and/or operation unit, comprising a user interface for operating the electronic measurement and/or operation unit of the at least one field device, wherein the user interface is designed as a tangible user interface.

2. The process control system of claim 1, wherein the tangible user interface comprises a sensitive control interface.

3. The process control system of claim 2, comprising a control element arranged so as to be movable on the control interface, which control element is associated with the at least one field device, and wherein the at least one control element is a miniaturization of the at least one field device.

4. The process control system of claim 2, wherein the user interface is designed such that the user interface can be varied with characteristics and/or a configuration of the process control system and/or at least one field device.

5. The process control system of claim 4, wherein the characteristics and/or configurations of the process control system are encoded visually, magnetically, or in terms of a surface quality in the user interface, and can be detected automatically by the control interface.

6. The process control system of claim 3, wherein the at least one control element is an article separate from the control interface, wherein the control element can be arranged on the control interface.

7. The process control system of claim 1, wherein the user interface has light sources to display a current status of the at least one field device.

8. The process control system of claim 2, comprising at least two control elements having a respective monitoring unit that monitors an interaction of the two field devices associated therewith, wherein the monitoring unit is designed such that, in the event that the two field devices do not interact, the two field devices cannot be operated by the two control elements.

9. The process control system of claim 2, comprising at least two control elements having a respective monitoring unit that monitors an interaction of the two field devices associated therewith, wherein the monitoring unit is designed such that, in the event that the two field devices cannot be operated together, the two field devices cannot be operated simultaneously by the two control elements.

10. The process control system of claim 1, comprising at least one blocking element for blocking or barring a control element for a user, wherein the at least one blocking element can be imposed via the control element, and the state of the field device can no longer be modified on said control element.

11. The process control system of claim 3, comprising a distance measurement device for measuring the distance between the user interface and the at least one control element, and which determines and deactivates the associated field device and/or the control of the field device beyond a predetermined distance.
